(19) United States
(12) Patent Application Publication
(10) Pub. No.: US 2014/0044111 A1
(43) Pub. Date: Feb. 13, 2014

(54) Frame Chaining for Bridged Traffic

(71) Applicant: Ravi Nuti, Santa Clara, CA (US)

(72) Inventor: Ravi Nuti, Santa Clara, CA (US)

(73) Assignee: Broadcom Coporation, Irvine, CA (US)

(21) Appl. No.: 13/569,559

(22) Filed: Aug. 8, 2012

(51) Int. Cl. H04W 40/00; H04W 84/12; H04L 12/56

(52) U.S. Cl. 370/338; 370/392

(57) ABSTRACT

A system chains data frames in a communication network. A frame burst including a plurality of frames is received. A destination address and priority of the plurality of frames are compared. The frames having a matching destination address and priority are grouped. The grouped frames are sent together for transmitting.

### TECHNICAL FIELD

The disclosure relates to frame chaining for bridged traffic.

### BACKGROUND

Gateways and router can include access points to control a flow of data frames in communication networks. The access points can include software and hardware devices to transmit and receive data across the networks. The access points can serve as the points of interconnection between wireless local area networks (WLAN), wired LAN and a fixed wire networks. The access points can connect users to other users within the networks.

### BRIEF DESCRIPTION OF THE DRAWINGS

The innovation may be better understood with reference to the following drawings and description. In the figures, like reference numerals designate corresponding parts throughout the different views.

FIG. 1 is a block diagram of an exemplary communication environment.

FIG. 2 is a block diagram of an exemplary access point.

FIG. 3 is a block diagram of an exemplary cut through forwarding connection.

FIG. 4 is a flowchart of an exemplary process for chaining frames.

FIG. 5 is a block diagram of an exemplary hot bridge cache.

FIG. 6 is a table showing an exemplary concurrent dual-band frame throughput in megabits per second (Mbps) with and without chaining.

FIG. 7 is a table of an exemplary frame throughput in Mbps with chaining activated and not activated.

FIG. 8 is an exemplary bar diagram corresponding to the table of FIG. 7.

### DETAILED DESCRIPTION

The discussion below references chaining together frames, such as for sending in an access point or bridge device. The chaining can reduce processing and increase a speed of handling frames, such as at the access point of the communication system. Frame traffic that is bridged from a wireless local area network (WLAN) to a wired local area network (LAN) or Ethernet, and from the LAN or Ethernet to the WLAN can be received and transmitted in bursts by the access point. The frames received at the LAN or Ethernet can belong to same source and destination and have the same priority. The frames having the same destination and priority can be grouped together into a packet chain. The packet chain can be used to forward the grouped chains at once, and frames in the group do not have to be processed one by one through the bridging process. Frames that do not include the same destination or priority can be processed and forwarded individually. For the WLAN driver, a source address can also be checked to determine chainable frames.

Features of this process can apply to router platforms and other platforms such as WLAN repeater/range extender platforms where the frames are bridged from one WLAN segment to another. The repeater can regenerate a network signal to extend a range of the existing network infrastructure. The repeater receives radio signals (e.g., 802.11 frames) from an access point, end user device, or another repeater and retransmits the frames. This can make it possible for a repeater located in between an access point and distant user to act as a relay for frames traveling back and forth between the user and the access point. For example, repeaters provide connectivity to remote areas that normally would not have wireless network access. An access point in a home may not cover the entire area where users need connectivity, such as a basement or patio. The placement of a repeater between the covered and uncovered areas, however, can provide connectivity throughout the entire space, and frame chaining can take place at the repeater.

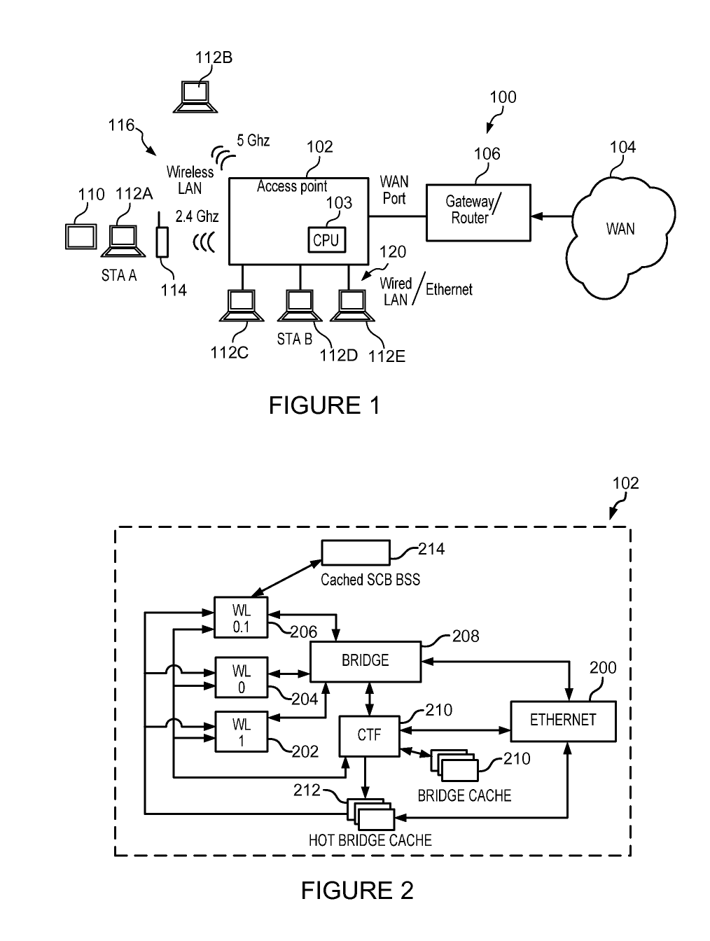

FIG. 1 is a block diagram of an exemplary communication environment 100. Switching in the communication environment 100 can include an access point 102 to connect devices on various local networks to each other, e.g., wireless devices at STA A and wired devices at STA B. The access point 102 can connect with the WAN 104 via a gateway and/or router 106 through a WAN port of the access point 102. The access point 102 can be implemented together with or separately from the gateway/router 106. The access point 102 can include a central processing unit or other processor 103 to execute logic to control a flow of frames between STA A and STA B. The access point 102 can also connect to a wide area network (WAN) 104, such as the Internet.

From the access point 102, communication information can be received and sent as data frames. A frame includes a formatted unit of data carried over a packet mode communication network. The data can include control information and user data also known as payload. The control information can provides data the network needs to deliver the user data, including source and destination addresses, priority information, error detection codes like checksums, and sequencing information. Control information can be found in packet headers and trailers, with payload data in between.

The data packets can be sent wirelessly to various devices such as a laptop 110, desktop computer 112A, B, and cellular phone or personal digital assistant 114. The information can be communicated via a WLAN 116 using different wireless communication protocols such as in accordance with the IEEE 802.11 standard. For explanation purposes, the information is shown being sent at various rates, such as 150 Mbps, 300 Mbps or 1 Gbps via various channels such as the 2.4 GHz and the 5 GHz bands. However, other rates and channels can be used.

The data packets can also be communicated via wired medium, e.g., copper and optical lines. Ports of the access point 102 can connect the wired connections to different computing devices on a local area network (LAN) 120, such as desktop computers 112C, D, E. The wired connections can include wired LAN and/or the Ethernet, e.g., in accordance with the IEEE 802.3 standard. The access point 102 can bridge two or more network segments having different protocols, such as by bridging information between the wireless and wired related devices, and repeat information packets of the same protocol type. The access point 102 can also route information packets from the WAN 104 to the LAN 120.

FIG. 2 is a block diagram of an exemplary access point 102. The access point 102 can include drivers for different types of devices to connect to. For example, the access point 102 can include an Ethernet driver 200, a 5 GHz wireless driver (e.g. WL1), a 2.4 GHz wireless driver (e.g. WL0), and a virtual driver (e.g. WL0.1). Other types of drivers can be used. The access point 102 can include a bridge module 208, e.g., a LINUX bridge, to send information packets from Ethernet devices 112C,D,E to wireless devices 110, 112A,B, 114 and from wireless devices 110, 112A,B, 114 to Ethernet devices 112C,D,E.

The bridge module 208 can connect with a bridge cache 210 or other database for storing information about the frames being bridged between the LAN/Ethernet and WLAN such as MAC address and port number. The bridge module can also connect with a hot bridge cache 212 described in more detail below. The hot bridge cache 212 can contain data of matched bridge cache entries. A basic criteria used to determine if a received frame is chainable can include that the frame destination address and priority match corresponding information in the hot bridge cache 212. For wireless drivers 202, 204, 206 additional matching criteria can be used to determine if a frame is chainable. For example, a receive cache 214 can store station (STA) MAC addresses and basic service set identification (BSSID) information for the received frames, to be checked with the destination and priority to determine if the frame is chainable when travelling from the wireless to Ethernet direction.

The bridge module 208 can include a cut-through forwarding module (CTF) 210 to forward a packet, or frames of packets, before the whole frame has been received, e.g., as soon as the destination address is processed. This cut-through forwarding can reduce latency of frames communicated through the access point 102. Packets with destination addresses matching the entries in the bridge cache 210 can be directly forwarded between the Ethernet and WLAN interfaces without having to go through the bridge module 208.

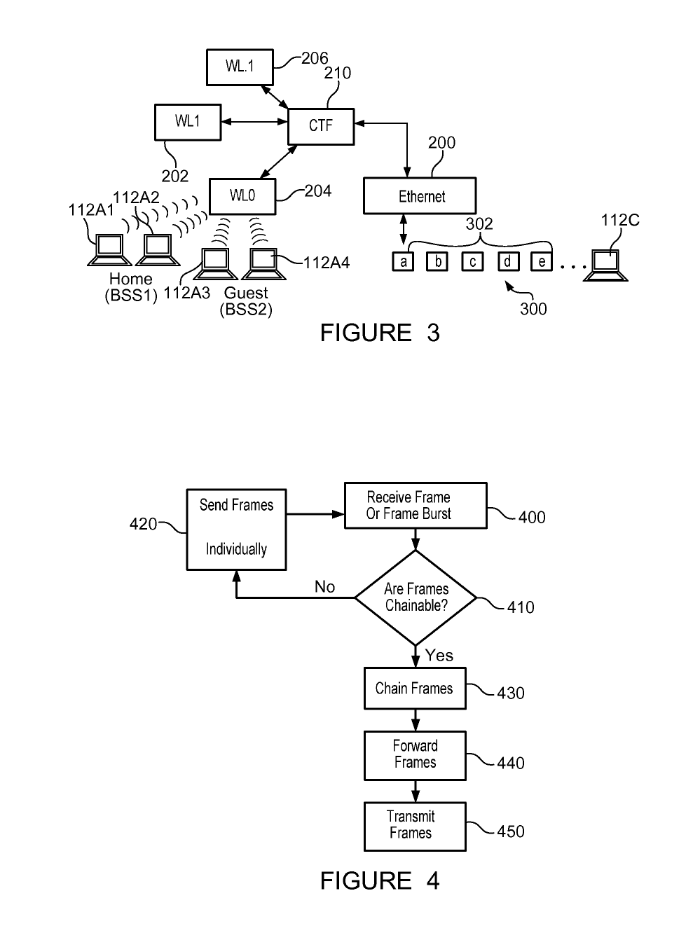

FIG. 3 is a block diagram of an exemplary CTF 210 connection between wireless drivers 202, 204 and 206 and the Ethernet driver 200. Communications traffic can be received and transmitted as bursts of frames 300a,b,c,d,e, etc. The burst of frames 300a,b,c,d,e can include frames having the same or different source, destination and priority. For explanation purposes, the burst of frames is being sent from Ethernet device 112C to wireless devices 112A4.

Frames that include the same destination and priority can be identified and grouped together into packet chain 302 of frames. For frames transferred in the WLAN to the Ethernet direction, alternative or additional criteria can be used to determine if the frames should be grouped, such as checking whether the frame is in sequence and/or a whole frame. Out of sequence frames and frame fragments may not be chained. The grouped chain of frames can be forwarded without processing the individual frames 300a,b,c,d,e one by one at each of the Ethernet driver 200, the CTF 210 and wireless driver 204. One frame in the chain 302, e.g., the first frame in the chain, can be processed and the other frames handled according to the processed frame. If it is determined that the frames 300a,b,c,d,e cannot be chained, e.g., the frames are from a different source, going to a different destination and/or of a different priority, then the frames 300a,b,c,d,e can be processed and forwarded individually.

Also, some frames in the burst may be chainable, e.g., 300b,d, and e, and other frames may not be chainable, e.g., 300a and c. In this situation, frames 300b,d and e can be sent together in a chain and frames 300a and c can be sent individually. Other scenarios are also possible. For example, frames received from multiple bursts that meet determined criteria may be chained.

FIG. 4 is a flowchart of an exemplary process for chaining frames. The process can be accomplished with hardware, software or firmware, or any combination thereof. The process can identify whether the frames are chainable, process a packet chain if the chains are chainable, and forward/transmit the processed packet chains to their destination. At block 400, a wireless or Ethernet driver receives a frame or burst of frames from the network. For example, the Ethernet driver 200 can receives a burst of frames 300a,b,c,d,e. The Ethernet driver can send the burst of frames 300a,b,c,d,e to the CTF 210. The CTF 210 can perform a frame error check and determine the source, destination and priority of the frames 300a,b,c,d,e. The CTF 210 can update the bridge cache 210 with this information.

At block 410, the process determines if any of frames 300a,b,c,d,e can be chained together. When frames 300a,b,c,d,e are received, such as from an Ethernet host or a WLAN station, corresponding LAN/Ethernet and WLAN device drivers, e.g., 200, 202, 204, 206 can be informed of the event using a hardware interrupt. In response to the interrupt indication, the driver e.g., drivers 200, 202, 204, 206 can schedule a handler to pull frames from a direct memory access (DMA) ring buffer and determine which frames are chainable as the frames are read from the DMA ring. To determine which frames in the burst, if any, are chainable, the CTF 210 can compare the destination and priority for the frames 300a,b,c,d,e. All frames from the burst of frames may be checked for the ability to be chained, or a determined portion of the frames in the burst can be checked.

Additionally or alternatively, frames from more than one burst can be checked at the same time to determine which frames if any are chainable. When the burst has frames destined to different mac addresses and/or different priorities and the hot bridge cache lookup succeeds then multiple chains can be built. For example, a received frame burst has thirty frames out of which twenty frames belong to destination A and ten frames belong to destination B. With information about destination A and destination B present in the hot bridge cache 212 two chains can be built. One chain includes twenty frames and other chain includes ten frames. This reduces the forwarding overhead from thirty frames to two frames.

For Ethernet traffic, the CTF 210 can determine that the frames 300a,b,c,d,e are chainable if the destination and priority match. More or less criteria may be used to determine if frames are chainable. For example, the source, destination and priority can be matched for the frames to be chained. Additional criteria for WLAN based frame chaining can include the source address of the frame matching the wireless station's MAC address, the BSSID of the frame matching the address of cached BSS, the frame is not a fragment, the frame is a quality of service (qos) frame type, includes no null data, the frame is not a duplicate, and the received frame is part of an aggregated MAC protocol data unit (AMPDU) that is destined to the same responder TID and not out of sequence. Fragmented frames can be excluded from framing because they can undergo a reassembly process before being chained.

WLAN drivers 202, 204, 206 can include more MAC protocol overhead compared to the Ethernet driver 200. Therefore, the WLAN driver 202, 204, 206 can maintain a receive cache 214 to match the additional parameters. Information saved in the receive cache 214 can include STA MAC address and BSSID information for the received frames. Additionally or alternatively, a cache can be used per WLAN station. In the case of the frames travelling from wireless to Ethernet, the WLAN drivers can perform STA MAC address and BSSID lookup from the receive cache 214 for each frame. Whether or not used with the chaining function, the caching mechanism can be used to bypass much of the wireless driver receive path for most of the frames. This can translate to reduced host CPU overhead even when chaining is disabled.

To help ensure secure communications, the frame chaining process for WLAN can be enabled on access points configured with open mode or WPA2 AES based security having WMM and AMPDU aggregation. Also chaining can be provided for the wireless stations that support similar configurations.

At block 420, if the destination or priority, or other criteria for WLAN chaining, do not match for any of the frames 300a,b,c,d,e, then such frames 300a,b,c,d and/or e are not chained and they are processed individually. At block 430, frames that are chainable can be chained. To chain the frames, the frame headers can be changed from 802.11 to 802.3/Ethernet headers, or vice versa, and the whole chain can be forwarded to the CTF 210. For example, the bridge module 208 can convert Ethernet headers to wireless device headers including a source address, destination address, fragment number, etc. for sending the chained frames to the WLAN. Time and processing power can be saved by utilizing the chained frames. For example, the STA MAC address and BSSID lookups can be accomplished for the first frame only, and need not be accomplished for each frame of the chain. In addition, receive processing is not needed for each frame in the chain.

At block 440, the chained frames can be forwarded. The CTF 210 can receive the chain from the Ethernet driver 200, or the WLAN driver 202, 204, 206 for frames coming from WLAN devices. The CTF 210 can perform bridge cache 210 lookups based on source and destination MAC addresses. The CTF 210 can update the bridge cache 210 entry and transmit the chain to an outgoing interface. The interface can include Ethernet or one of the wireless interfaces. For example, an access point can include one WLAN interface and a repeater can include two interfaces. Based on the destination MAC address the frame can be sent to either of the interfaces. Processing can be done individually for each non-chainable frame 300a,b,c,d,e in the burst. For chained frames, the entire chain of frames can be forwarded using a single function call.

At block 450, the chain of frames can be transmitted to the network. For Ethernet driver 200 transmit chain processing, the chain of frames arriving from CTF 210 can be submitted to direct memory access (DMA) for transmission, e.g., to device 112C. Chaining of the frames allows for not having to conduct back and forth processing between WLAN receive, CTF forward and Ethernet transmit for every individual frame. This can save cache resources and time.

When the WLAN driver 202, 204, 206 receives a chained packet from the CTF 210, if aggregation MAC service data unit (AMSDU) is not used with chaining, frames can be queued at the aggregation MAC protocol data unit (AMPDU) layer. There can be no need to process each frame individually. If a first frame of the chain passes through the AMPDU layer of the processing then rest of frames can skip these processing steps and can be directly queued to the AMPDU queue for the next layer processing in the wireless driver. Therefore, processing time can be saved. Frame chaining can also help to achieve aggregation MPDU density since more frames may be pushed than without frame chaining. As many frames in the burst that can be chained may be chained and remaining frames can be sent individually.

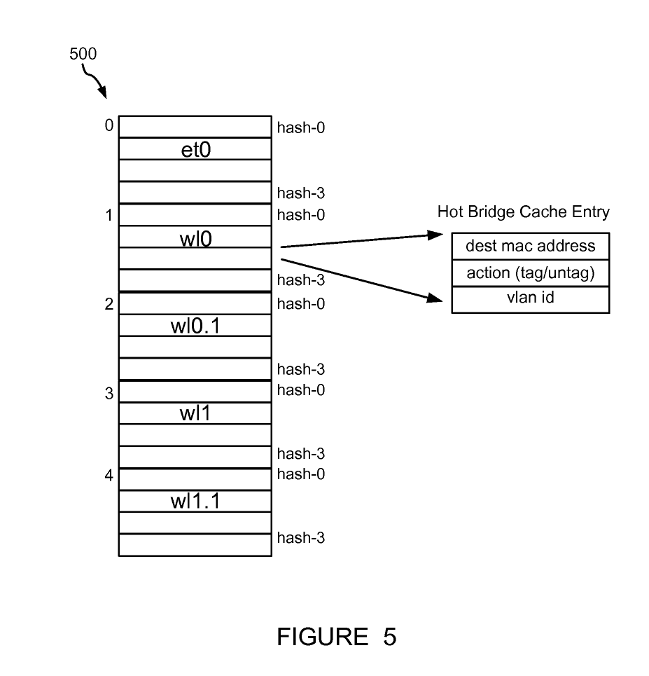

FIG. 5 is a block diagram of an exemplary hot bridge cache layout 500. The hot bridge cache 212 can store information of matched bridge cache 210 frame entries, such as for recent matches. The data of matched bridge cache 210 entries can be maintained and updated by the CTF 210. The information can be searched or queried by the wireless driver, e.g., wireless drivers w|0, w|1, w|1.1, etc, and Ethernet drivers, e.g., Ethernet driver et0, when a data frames are received. The hot bridge cache 212 entries can be maintained per driver to help accommodate faster lookup for frame chaining than if the hot bridge cache 212 is not used. For example, a number of entries to be searched can be reduced. Hot bridge cache entries for drivers can include MAC address entries for traffic received on that interface.

The hot bridge cache 212 can store information about destination MAC address and virtual LAN identification (vlan id), tag/untag action information. Frames having the same destination MAC address and frame priority can be chained and forwarded together at one time. Therefore, CTF bridge cache lookups only need to be performed for one frame in the chain. The VLAN header may be added or removed before forwarding the frame. The action information indicates whether to add/remove the header. The VLAN id value can be written in VLAN header. The information may be maintained for both frame traffic travelling from WLANs 202, 204, 206 to the LAN or Ethernet 200, and for traffic from the LAN or Ethernet 200 to WLANs 202, 204, 206.

Frame traffic flow passing through the bridge 208 for transmission control protocol (TCP) based protocols can be bidirectional by virtue of TCP acknowledgement (ACK) packets in the opposite direction of TCP data packets. When a WLAN or LAN/Ethernet driver receives a frame, the CTF 210 can compare the frame against the hot bridge cache 212 entry as part of determining if the frame is chainable. The CTF 210 can provide a mechanism to allow the WLAN or LAN/Ethernet driver instances to register unique memory locations where the hot bridge cache entry data is saved. There can be multiple entries per WLAN or LAN/Ethernet driver instance. The hot bridge cache 212 entries can be indexed using the driver interface instance identifier and hash obtained from the destination MAC address. This can improve the probability of having unique entries for bi-directional traffic.

The WLAN and LAN/Ethernet drivers can match multiple hot cache entries to allow multiple chains per burst to be built. For example, if a burst of forty frames is received out of which twenty frames belong to destination A and twenty frames belong to destination B, without multiple chains the first twenty frames can be sent as a single chain and remaining sent individually. When multi-chaining is used, multiple destination addresses and frame priorities can be matched and chains of frames can be built per destination. The multi-chaining can enable multiple chains to be forwarded and savings can be obtained when traffic to multiple destinations is present.

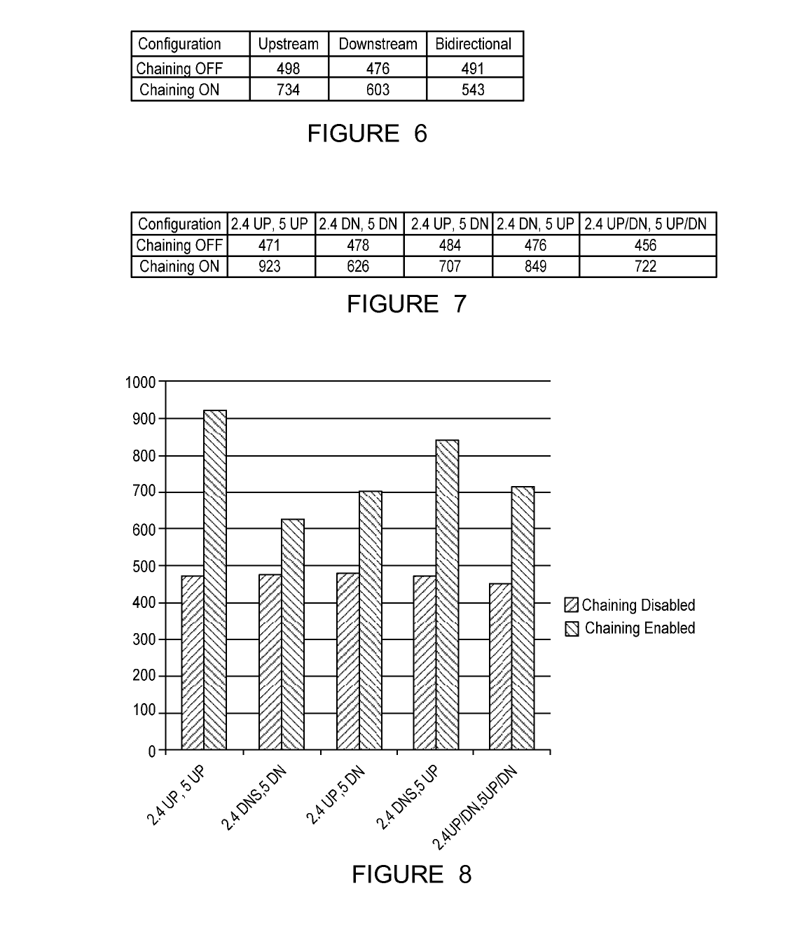

FIG. 6 is a table showing an exemplary frame throughput in Mbps for the 802.11ac protocol configured in channel 161/80 with and without chaining. The values are for explanation purposes only and may vary depending on an implementation. With chaining implemented bridging performance can be improved in the upstream, downstream and bidirectional directions. Downstream can indicate traffic in the Ethernet to the WLAN direction and upstream can indicate the WLAN to the Ethernet direction.

Some advantages of chaining can include processing only once for frames in the entire chain, not frame by frame. Changes can be applied for rest of the frames in the chain when the first frame in the chain is processed. This can reduce average packet processing time and required power. In addition, there may be no need to go from the start of the receive process to the end of transmit individually for each frame. Processing can be more localized, e.g., at the CTF 210. A back and forth of the code path can also be reduced, which can help reduce a number of times the cache is accessed. Additionally, about 15-20% idle time of the CPU 103 can occur when chaining is used. Upstream and bi-directional throughput may be more consistent. An impact of changes in non-data path functions can be reduced with the cache running more efficiently in chaining mode. Instruction cache misses may also be reduced.

FIGS. 7 and 8 are a table and corresponding bar diagram of exemplary frame throughput in Mbps with chaining activated and not activated. Frame throughput may be improved during concurrent dual band performance with a chaining feature enabled. The 2.4 G interface on the access point 102 is configured in channel 6/40 MHz and 5 G interface is configured in channel 161/80 MHz.

While various embodiments have been described, it will be apparent that many more embodiments and implementations are possible within the scope of the claims.

What is claimed is:

1. A method for forwarding frames, comprising:
receiving a frame burst including a plurality of frames;
comparing a destination address and priority of the plurality of frames;
grouping the frames having a matching destination address and priority; and
sending the grouped frames together for transmitting.

2. The method of claim 1 further comprising determining if the plurality of frames includes any frame fragments, and not grouping the frames that are fragments.

3. The method of claim 1 further comprising storing the destination address and the priority in a cache for fast lookup.

4. The method of claim 1 further comprising determining if the frame burst is received from an Ethernet host or a wireless local area network station.

5. The method of claim 4 further comprising comparing a source address of the plurality of frames, in addition to the destination and the priority, if the frame burst is received from the wireless local area network station.

6. The method of claim 5 further comprising grouping the frames having matching source addresses, destination address and priority for transmitting together.

7. The method of claim 6 further comprising converting a frame header of the grouped frames to an Ethernet protocol header before sending.

8. The method of claim 7 further comprising storing destination information of recently matched frames.

9. The method of claim 8 where the stored destination for recently matched frames is organized by wireless local area network and Ethernet drivers.

10. A access point, comprising:
an Ethernet driver to receive communication frames from an Ethernet host;
a wireless local area network driver to receive communication frames from a wireless local area network station and group frames that meet a determined criteria; and
a cut through forwarding module to send communication frames from the Ethernet driver to the wireless local area network station and from the wireless local area network driver to the Ethernet host, where the cut through forwarding module forwards the chain of frames.

11. The access point of claim 10 where the determined criteria includes a destination and a priority of the frame.

12. The access point of claim 11 where the determined criteria further includes a source of the frame.

13. The access point of claim 10 further including a cache to store information about grouped frames.

14. The access point of claim 13 where the information includes destination information.

15. The access point of claim 14 where the cut through forwarding module is configured to compare destination information of incoming frames with destination information stored in the cache to determine if the destination match.

16. The access point of claim 15 where the cut though forwarding module is configured to group frames with matching destination information and forward the group of frames together.

17. A method for processing frames in a communication network, comprising:
receiving a frame burst including a plurality of frames;
comparing a destination address and priority of the plurality of frames;
grouping frames having a matching destination address and priority;
processing only the first frame of the group of frames upon transmitting the group of frames; and
processing ungrouped frames individually upon transmitting the individual frames.

18. The method of claim 17 further comprising updating headers of frames in the group of frames from Ethernet headers to wireless local area network headers upon transmitting the group of frames from an Ethernet host to a wireless local area network station, and updating headers of frames in the group of frames from wireless local area network headers to Ethernet headers upon transmitting the group of frames from a wireless local area network driver to an Ethernet host.

19. The method of claim 17 further comprising comparing the destination and priority of multiple bursts of frames.

20. The method of claim 17 further comprising comparing a source address if the burst of frames is sent by a wireless local area network station.
